(19) United States
(12) Patent Application Publication
(10) Pub. No.: US 2017/0008632 A1
(43) Pub. Date: Jan. 12, 2017

(54) AIRCRAFT PASSENGER RESTRAINT SYSTEM WITH THREE-POINT SEAT BELT AND STRUCTURAL MOUNTED AIRBAG

(71) Applicants: B/E AEROSPACE, INC., WELLINGTON, FL (US); TAKATA PROTECTION SYSTEMS INC., POMPANO BEACH, FL (US)

(72) Inventors: THOMAS CARLTON EBERLE, WINSTON-SALEM, NC (US); MACK THOMAS MOORE, ADVANCE, NC (US); ALEN WYSS, WINSTON-SALEM, NC (US); JOE GUTOSKY, KERNERSVILLE, NC (US); RANDY PENLEY, WINSTON-SALEM, NC (US); STEPHEN BRYANT ADKINS, CORAL SPRINGS, FL (US); MARK EDWARD DEEVEY, CORAL SPRINGS, FL (US); MARC SCHATELL, WINSTON-SALEM, NC (US); KRIS CLARK, SUMMERFIELD, NC (US); MATTHEW KARL, WINSTON-SALEM, NC (US)

(21) Appl. No.: 15/205,563

(22) Filed: Jul. 8, 2016

Related U.S. Application Data
(60) Provisional application No. 62/190,022, filed on Jul. 8, 2015.

(51) Int. Cl. B64D 11/06; B64D 11/00

(52) U.S. Cl. CPC B64D 11/06205; B64D 11/0601; B64D 11/062; B64D 11/0015; B64D 11/0619; B64D 2201/00; B60R 2021/0093

(57) ABSTRACT

An aircraft passenger restraint and protection system including an aircraft seat mounted at an oblique angle to a direction of forward travel, a multi-point seat belt associated with the aircraft seat, and a structural mounted airbag located forward of the aircraft seat.

### CROSS-REFERENCE TO RELATED APPLICATION

This application claims priority from U.S. application Ser. No. 62/190,022 filed Jul. 8, 2015, the entirety of which is incorporated by reference herein.

### TECHNICAL FIELD AND BACKGROUND OF THE INVENTION

The present invention relates generally to a seat occupant restraint and protection system, and more particularly, to utilization of a forward structural mounted airbag in conjunction with a seat belt having an integral retractable shoulder belt (i.e., three-point restraint) for occupant protection and to certify oblique mounted aircraft seats.

Seat belts are vehicle safety devices designed to secure the occupant of a vehicle against harmful movement that may result during a collision or sudden stop. A seat belt generally functions to reduce the likelihood of serious injury or death in a vehicle collision by reducing the force of secondary impacts with interior strike hazards, by preventing the occupant from being ejected from the seat, and by keeping the occupant positioned correctly for maximum effectiveness of the airbag when the vehicle is so equipped.

While car seats are mounted forward facing, aircraft seats can be oblique mounted to maximize seating density, particularly in premium seating classes outfitted with individual passenger suites. In such suites, the seat can be mounted within a living area defined by partition walls, dividers and furniture. Oblique mounted seats require controlling the load on the lower spine, lower torso, Head Injury Criterion (HIC) levels for the head, neck twist and upper spinal load to meet FAA and EASA certification requirements. Prior to the present invention no such solution existed to meet such certification requirements.

### BRIEF SUMMARY OF THE INVENTION

It is an object of the invention to provide a restraint and protection system for airline passengers.

It is another object of the invention to provide a passenger restraint and protection system for passengers seated in a direction other than forward facing.

It is yet another object of the invention to provide a passenger restraint and protection system for passengers seated at an oblique angle to directly forward facing.

It is yet another object of the invention to provide and airliner passenger suite equipped with a passenger seat, a multi-point restraint associated with the seat, and an airbag positioned to inflate to absorb impact from the passenger.

It is yet another object of the invention to provide a passenger restraint and protection system for oblique mounted seats which meets FAA and EASA certification requirements for controlling the load on the lower spine, lower torso, head injury criterion (HIC) levels for the head, neck twist and upper spinal load.

To achieve the foregoing and other objects and advantages, in a first embodiment the present invention provides an aircraft passenger restraint and protection system including an aircraft seat mounted at an oblique angle to a direction of forward travel, a multi-point seat belt associated with the aircraft seat, and a structural mounted airbag located forward of the aircraft seat.

In another aspect, the airbag can be configured to deploy in response to a rapid deceleration event and cover an impact zone of a passenger's head and upper body.

In another aspect, the aircraft seat can be mounted at an angle from 1 to 90 degrees from the direction of forward travel, more preferably from 15 to 45 degrees from the direction of forward travel.

In another aspect, the multi-point seat belt can be a three-point seat belt having a lap belt and a shoulder belt.

In another aspect, the airbag can be mounted within a partition wall positioned forward of the aircraft seat.

In another aspect, the airbag can be a passive inflatable restraint triggered to deploy by a battery powered crash sensor configured to fire after a threshold of a dynamic impact is registered by a mechanical crash sensor unit.

In another aspect, the airbag can inflate to cover portions of a partition wall directly forward of and to one side of the aircraft seat within head, hand, wrist, arm and elbow striking distance.

In another aspect, the airbag when inflated can extend partway alongside the aircraft seat to prevent lateral head movement.

In another aspect, the airbag can be configured to deflate after impact to allow unencumbered egress from the aircraft seat.

In another embodiment the present invention provides an aircraft passenger suite including an aircraft seat mounted within the aircraft passenger suite at an oblique angle to a direction of forward travel, a multi-point seat belt associated with the aircraft seat, and an airbag mounted within a structure forward of the aircraft seat.

In another aspect, the structure can be a static partition wall defining a forward boundary of the aircraft passenger suite.

In another aspect, the suite can further include a desk and video monitor positioned directly forward of the aircraft seat, wherein the airbag is mounted within a partition wall to one side of the desk and video monitor.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Features, aspects and advantages of the present invention are better understood when the following detailed description of the invention is read with reference to the accompanying drawings, in which:

FIG. 1 is a front and right side perspective view of an airliner passenger suite according to an embodiment of the invention equipped with an oblique mounted seat, a multi-point seat belt, and a structural mounted airbag;

FIG. 2 is a left side and rear perspective view of the suite of FIG. 1;

FIG. 3 is a left side perspective view of the suite of FIG. 1; and

FIG. 4 is a top plan view of the suite of FIG. 1.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

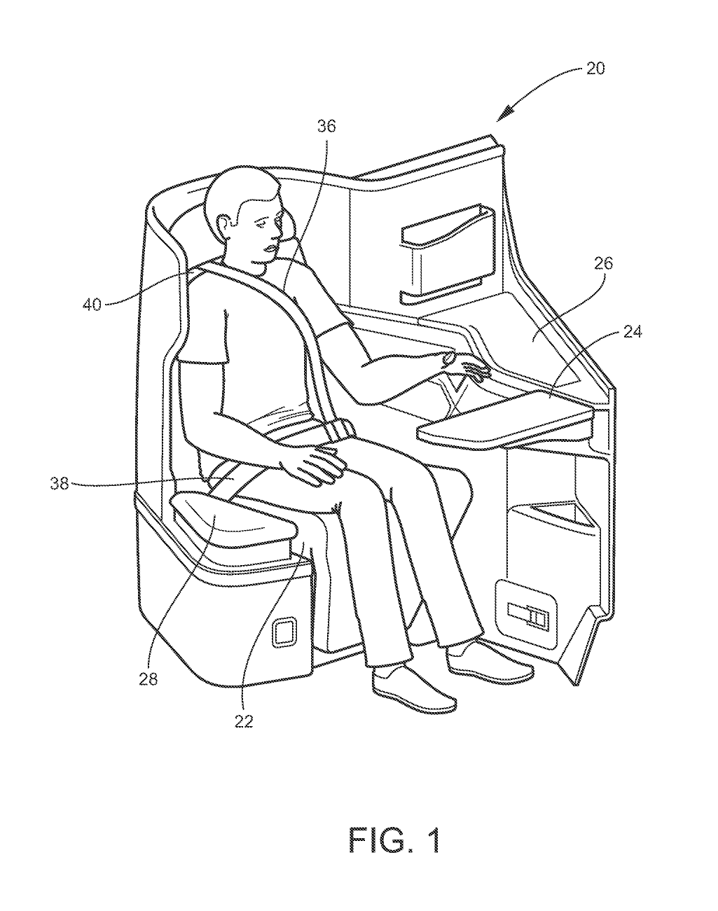

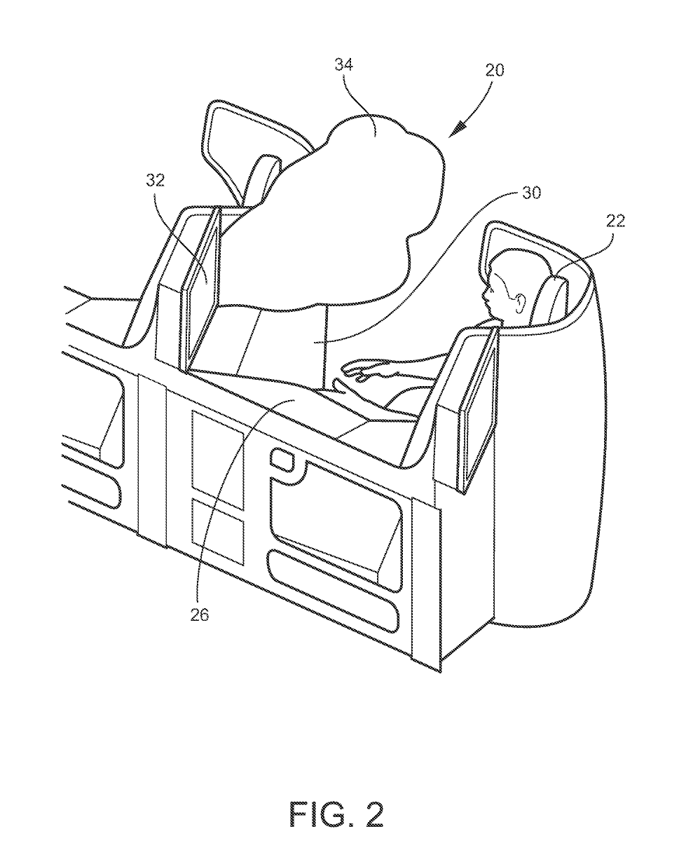

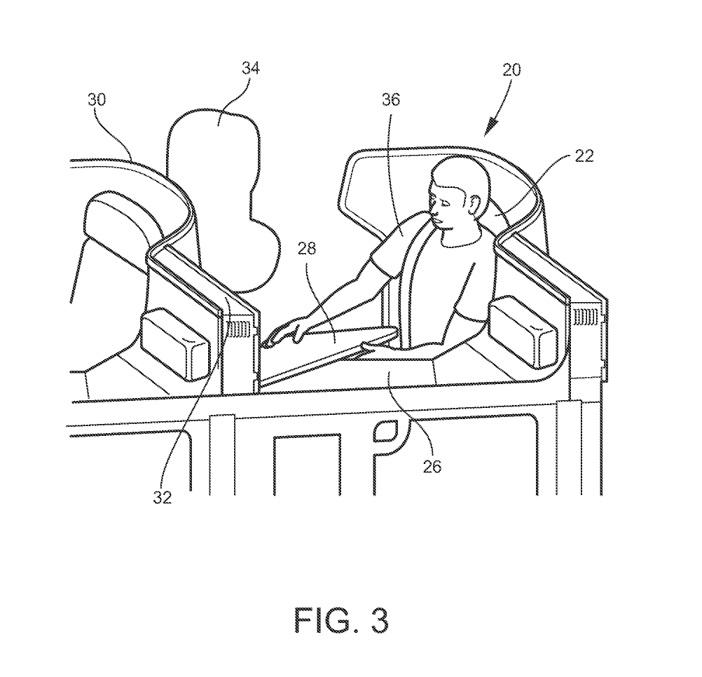

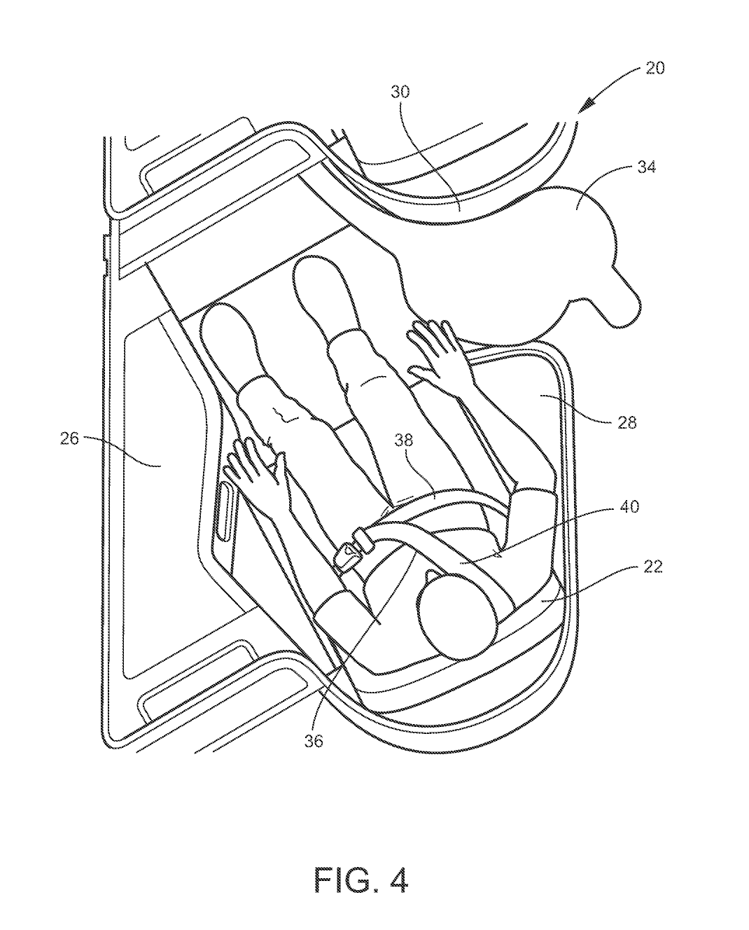

FIGS. 1-4 illustrate various views of an airliner passenger suite 20 having an aircraft passenger seat 22 mounted therein. Aircraft seat 22 is oblique mounted, meaning that the seat is mounted at an angle to the direction of forward vehicle travel, and can be mounted as any one of forward facing, rear facing and side facing. In one embodiment aircraft seat 22 can be mounted from 1 to 90 degrees from directly forward facing, more preferably from 15 to 45 degrees from directly forward facing.

Aircraft seat 22 can be recline or lie-flat capable, and therefore selectively adjustable to achieve various sitting and sleeping positions between upright and horizontal. Aircraft seat 22 can be positioned within the suite 20 in proximity of a deployable tray table 24, left side console 26, and right side console 28. Aircraft seat 22 faces a partition wall 30 forming a forward boundary of suite 20 and dividing suite 20 from an adjacent suite which can be the same of different. Partition wall 30 can serve to divide adjacent suites as well as support a video monitor 32 positioned directly forward of the aircraft seat 22. The partition wall 30 can curve inward in a direction of the aircraft seat 22 to one side of the video monitor 30 to accommodate the seat within a longitudinally adjacent suite and allow a nested suite arrangement to maximize seating density. The same partition curvature can be provided immediately behind the aircraft seat 22 to permit nesting with another longitudinally adjacent suite.

Suite 20 is equipped with a forward structural mounted airbag 34 in conjunction with a multi-point seat belt 36 having an integral retractable shoulder belt (e.g., three-point seat belt) for seat occupant restraint and protection to meet the FAA and EASA certification requirements for oblique mounted aircraft seats. The use of the structural mounted airbag 34 in conjunction with the multi-point seat belt 36 controls the seat occupant's upper body, head, and torso area in the event of a collision, sudden stop, rapid deceleration event, etc., collectively referred to herein as an “event.” The multi-point seat belt 36 controls the load to the lower spine and lower torso to meet the certification requirements. The structural mounted airbag 34 is utilized to control the HIC levels for the head as well as neck twist and upper spinal loads. Used together, the upper and lower spinal loads are reduced to meet the certification requirements.

The structural mounted airbag 34, shown deployed throughout the figures, can be a passive inflatable restraint mounted within the partition wall 30 and triggered by a battery powered crash sensor. The sensor can be designed to fire (i.e., trigger airbag inflation) after the threshold of a dynamic impact is registered by a mechanical crash sensor unit (MCSU). Once triggered, the airbag 34 inflates to cover the impact zone of the occupant's head and upper body. As shown, the airbag 34 inflates to cover portions of the partition wall 30 directly forward of and to one side of the seat occupant, e.g., those portions of the partition wall 30 and surrounding static fixtures within head, hand, wrist, arm and elbow striking distance. The airbag 34 can have integral features, e.g., a shape, designed to limit head rotation and reduce HIC values to meet oblique seat certification requirements. In an exemplary embodiment, the airbag 34 can have a greatest thickness where the partition wall 30 is closest to the seat occupant and can extend partway alongside the aircraft seat 22 to prevent extreme lateral movement of the head. Once the airbag 34 is impacted by the seat occupant and/or after inflation, the airbag 34 can be configured to deflate and fall out of the way to allow unencumbered seat egress.

The seat belt 36 can be a three-point seat belt having a lap belt 38 and a sash belt 40 or “shoulder belt.” The lap belt 38 and the sash belt 40 can be unitized, but in a preferred embodiment are separable thereby allowing the sash belt 40 to be disengaged from the lap belt 38 and stowed during the taxi, take-off and landing (TTOL) portions of the flight. One or more of the lap belt 38 and the sash belt 40 can utilize a conventional retractable belt mechanism that limits the amount the respective belt can unwind during an event. An active or passive pre-tensioner (e.g., inertial reel) can be utilized depending on the desired occupant kinematics to meet the certification requirements for a given application. The retractable sash belt 40 controls the movement of the occupant's upper body and reduces the loads to the lower spine to meet oblique seat certification requirements.

The lap belt 38 is positioned over the waist, while the sash belt 40 is positioned diagonally over one shoulder (e.g., the outboard shoulder) and buckles inboard of the occupant's lap. The sash belt 40 can attach to the lap belt tongue or may have a tongue and buckle separate from those of the lap belt 38.

One or more of the lap belt 38 and the sash belt 40 can utilize a locking retractor to provide the occupant the convenience of some free movement of the upper torso while limiting such movement in an event. Belt length is stowed on the spring-loaded reel equipped with an inertial locking mechanism that stops the belt from extending off the reel during severe deceleration. Inertial mechanisms can include belt-sensitive locks based on a centrifugal clutch activated by rapid deceleration of the belt from the reel. The belt can be pulled from the reel slowly and gradually, such as when the occupant extends the belt to fasten it. A sudden rapid pull of the belt causes the reel to lock, thereby restraining the seat occupant in position. A pre-tensioner can be utilized to tighten the sash belt 40 to reduce motion of an occupant in an event. The pre-tensioner can be triggered by a sensor, and can utilize explosively expanding gas to drive a piston that retracts the belt.

By utilizing the structural mounted airbag 34 and multi-point seat belt 36 in conjunction with each other, both the upper body and lower body spinal HIC requirements can be met, whereas utilizing one component without the other fails to meet the certification requirements for either the upper or lower spinal areas.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. An aircraft passenger restraint and protection system, comprising:
an aircraft seat mounted at an oblique angle to a direction of forward travel;
a multi-point seat belt associated with the aircraft seat; and
a structural mounted airbag located forward of the aircraft seat.

2. The aircraft passenger restraint and protection system according to claim 1, wherein the airbag is configured to deploy in response to a rapid deceleration event and cover an impact zone of a passenger's head and upper body.

3. The aircraft passenger restraint and protection system according to claim 1, wherein the aircraft seat is mounted at an angle from 1 to 90 degrees from a direction of forward travel.

4. The aircraft passenger restraint and protection system according to claim 1, wherein the aircraft seat is mounted at an angle from 15 to 45 degrees from a direction of forward travel.

5. The aircraft passenger restraint and protection system according to claim 1, wherein the multi-point seat belt is a three-point seat belt having a lap belt and a shoulder belt.

6. The aircraft passenger restraint and protection system according to claim 1, wherein the airbag is mounted within a partition wall located forward of the aircraft seat.

7. The aircraft passenger restraint and protection system according to claim 1, wherein the airbag is a passive inflatable restraint triggered to deploy by a battery powered crash sensor configured to fire after a threshold of a dynamic impact is registered by a mechanical crash sensor unit.

8. The aircraft passenger restraint and protection system according to claim 1, wherein the airbag inflates to cover portions of a partition wall directly forward of and to one side of the aircraft seat within head, hand, wrist, arm and elbow striking distance.

9. The aircraft passenger restraint and protection system according to claim 1, wherein the airbag when inflated extends partway alongside the aircraft seat to prevent lateral head movement.

10. The aircraft passenger restraint and protection system according to claim 1, wherein the airbag is configured to deflate after impact to allow unencumbered egress from the aircraft seat.

11. An aircraft passenger suite, comprising:
an aircraft seat mounted within the aircraft passenger suite at an oblique angle to a direction of forward travel;
a multi-point seat belt associated with the aircraft seat; and
an airbag mounted within a structure forward of the aircraft seat.

12. The aircraft passenger suite according to claim 11, wherein the aircraft seat is mounted at an angle from 1 to 90 degrees from a direction of forward travel.

13. The aircraft passenger suite of claim 11, wherein the aircraft seat is mounted at an angle from 15 to 45 degrees from a direction of forward travel.

14. The aircraft passenger suite according to claim 11, wherein the multi-point seat belt is a three-point seat belt having a lap belt and a shoulder belt.

15. The aircraft passenger suite according to claim 11, wherein the structure is a static partition wall defining a forward boundary of the aircraft passenger suite.

16. The aircraft passenger suite according to claim 11, wherein the airbag is a passive inflatable restraint triggered to deploy by a battery powered crash sensor configured to fire after a threshold of a dynamic impact is registered by a mechanical crash sensor unit.

17. The aircraft passenger suite according to claim 11, wherein the airbag inflates to cover portions of a partition wall directly forward of and to one side of the aircraft seat within head, hand, wrist, arm and elbow striking distance.

18. The aircraft passenger suite according to claim 11, wherein the airbag when inflated extends partway alongside the aircraft seat to prevent lateral head movement.

19. The aircraft passenger suite according to claim 11, wherein the airbag is configured to deflate after impact to allow unencumbered egress from the aircraft seat.

20. The aircraft passenger suite according to claim 11, further comprising a video monitor positioned directly forward of the aircraft seat, wherein the airbag is mounted within a partition wall to one side of the video monitor.
